(19) United States
(12) Patent Application Publication
(10) Pub. No.: US 2006/0078479 A1
(43) Pub. Date: Apr. 13, 2006

(54) Filter assembly for an exhaust treatment device

(75) Inventors: Alexander G. Panov, Dunlap, IL (US); Mari Lou Balmer-Millar, Chillicothe, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/959,130

(22) Filed: Oct. 7, 2004

(51) Int. Cl. B01D 50/00

(52) U.S. Cl. 422/177

(57) ABSTRACT

A filter assembly is provided for an exhaust treatment device. The filter assembly has an inlet flow member and an outlet flow member. The filter assembly also has a particulate filtration medium configured to remove particulate matter from an exhaust flow. The filter assembly further has at least one catalyzed filtration medium in contact with the particulate filtration medium. The catalyzed filtration medium has a porosity greater than the particulate filtration medium.

### TECHNICAL FIELD

This disclosure relates generally to a filter assembly and, more particularly, to a filter assembly for use in an exhaust treatment device.

### BACKGROUND

Internal combustion engines, including diesel engines, gasoline engines, natural gas engines, and other engines known in the art may exhaust a complex mixture of air pollutants. The air pollutants may be composed of gaseous compounds, which may include nitrogen oxides and carbon monoxide, and solid particulate matter, which may include unburned carbon particulates called soot.

Due to increased attention on the environment, exhaust emission standards have become more stringent, and the amount of nitrogen oxides and particulates emitted from an engine may be regulated depending on the type of engine, size of engine, and/or class of engine. One method that has been implemented by engine manufacturers to comply with the regulation of the particulate matter has been to remove the particulate matter from the exhaust flow of an engine using a particulate trap. A particulate trap includes a filter assembly designed to trap particulate matter.

Various filter assemblies may be implemented to trap particulate matter. For example, U.S. Patent Application Publication No. 2002/0141910 A1 (the '910 publication) to Adiletta published on Oct. 3, 2002, describes using a filter assembly that includes a pleated microporous filter medium. The filter medium is disposed between two support members and separated from other filter media by inlet and outlet cells. The filter medium and support members include a catalyst coating to improve a regeneration process of the filter assembly. During operation, exhaust gas flows into the inlet cells, through the filter medium and support elements, and out through the outlet cells.

Although the filter assembly of the '910 publication may remove particulates from an exhaust flow of an engine, the filter assembly may not affect the amount of gaseous emissions exhausted to the environment. In addition, because the regeneration promoting catalyst filter only exists as a surface coating on the particulate filter medium and support members of the '910 publication, the effectiveness of the catalyst may be minimal. Further, because the filter medium is not a deep bed type medium, the running time between regeneration intervals may be short and the backpressure build up within an attached exhaust system excessive.

The disclosed filter assembly is directed to overcoming one or more of the problems set forth above.

### SUMMARY OF THE INVENTION

In one aspect, the present disclosure is directed to a filter assembly. The filter assembly includes an inlet flow member and an outlet flow member. The filter assembly also includes a particulate filtration medium configured to remove particulate matter from an exhaust flow. The filter assembly further includes at least one catalyzed filtration medium in contact with the particulate filtration medium. The catalyzed filtration medium has a porosity greater than the particulate filtration medium.

In another aspect, the present disclosure is directed to a method of treating an exhaust flow. The method includes directing the exhaust flow through an inlet flow member and through a particulate filtration medium to remove particulates from the exhaust flow. The method also includes directing the exhaust flow through a catalyzed filtration medium that is in contact with the particulate filtration medium and has a porosity greater than the particulate filtration medium. The method further includes directing the exhaust flow through an outlet flow member.

### BRIEF DESCRIPTION OF THE DRAWINGS

FIG. 1 is a diagrammatic illustration of an exhaust treatment device according to an exemplary disclosed embodiment;

FIG. 2 is a pictorial illustration of filter assembly according to an exemplary disclosed embodiment;

FIG. 3 is a pictorial illustration of filter assembly according to an exemplary disclosed embodiment; and

FIG. 4 is a pictorial illustration of filter assembly according to an exemplary disclosed embodiment.

### DETAILED DESCRIPTION

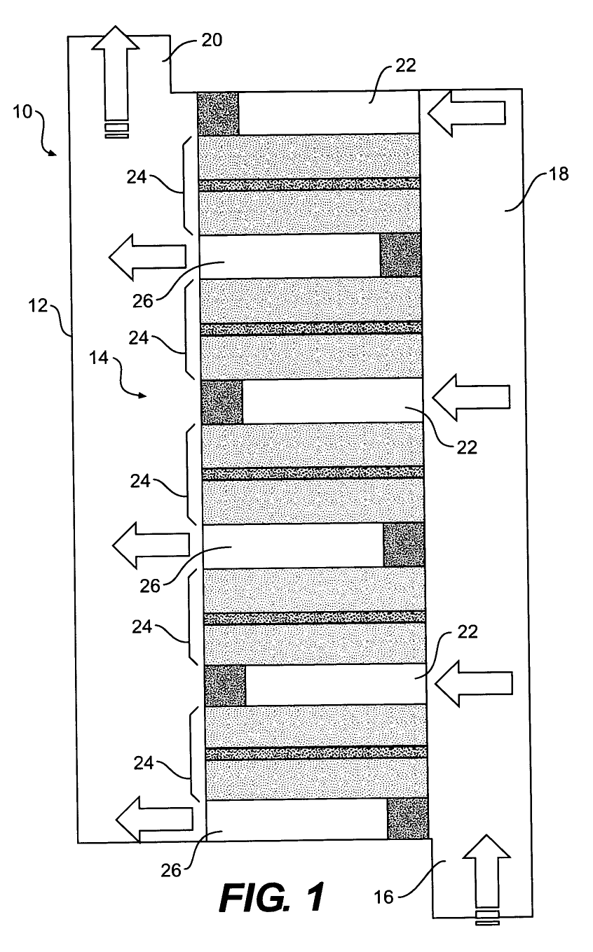

FIG. 1 illustrates an exemplary exhaust treatment device 10. Exhaust treatment device 10 may be configured to receive emissions from an exhaust-producing system (not shown) and to remove particulates and gaseous compounds from the emissions before being exhausted to the atmosphere. Exhaust treatment device 10 may include a housing 12 and a filter assembly 14 disposed within housing 12.

Housing 12 may have an inlet 16 configured to receive an exhaust flow from the exhaust-producing system, a main chamber 18, and an outlet 20. Inlet 16 may have a substantially circular cross-section. It is also contemplated that inlet 16 may have a differently shaped cross-section such as oval, square, rectangular, triangular, or any other suitable cross-section. Inlet 16 may protrude from a first end of housing 12 in a length direction of housing 12. Main chamber 18 may be located between inlet 16 and outlet 20, may have a substantially oval-shaped cross-section along a length direction, and may include rounded outer surfaces. It is also contemplated that housing 12 may have a cross-sectional shape other than oval such as, for example, circular, square, rectangular, or another appropriate shape. Outlet 20 may have a substantially circular cross-section. It is also contemplated that outlet 20 may have a differently shaped cross-section such as oval, square, rectangular, triangular, or any other suitable cross-section. Outlet 20 may protrude from a second end of housing 12 in the length direction of housing 12, opposite the first end. It is contemplated that inlet 16 and/or outlet 20 may alternately protrude from a side of housing 12, orthogonal or tangential to the length direction.

Filter assembly 14 may be disposed within main chamber 18 and include components that function to treat exhaust as it is flows between inlet 16 and outlet 20. Specifically, exhaust emissions may enter exhaust treatment device 10 via inlet 16 and flow in parallel through a plurality of inlet flow members 22 to a plurality of filter packs 24 in parallel relation, and through a plurality of outlet flow members 26 to exit exhaust treatment device 10 via outlet 20. It is contemplated that one or more of filter packs 24 may alternately be arranged to receive the gaseous emissions in series relation. Filter pack 24 may be in contact with both inlet flow member 22 and outlet flow member 26 and may include a means for sealing filter pack 24 to inlet and outlet flow members 22, 26. Exhaust treatment device 10 may also include a means for sealing filter assembly 14 to one or more ends and sides of housing 12. These means for sealing may include, for example, a ceramic paste, a weld, a braze, a compression of filter pack 24 and/or inlet flow and outlet flow members 22, 26, a gasket, or any other means known in the art. The number of filter packs 24 within exhaust treatment device 10 may be variable and depend on the back pressure, filtration, and size requirements of a particular application.

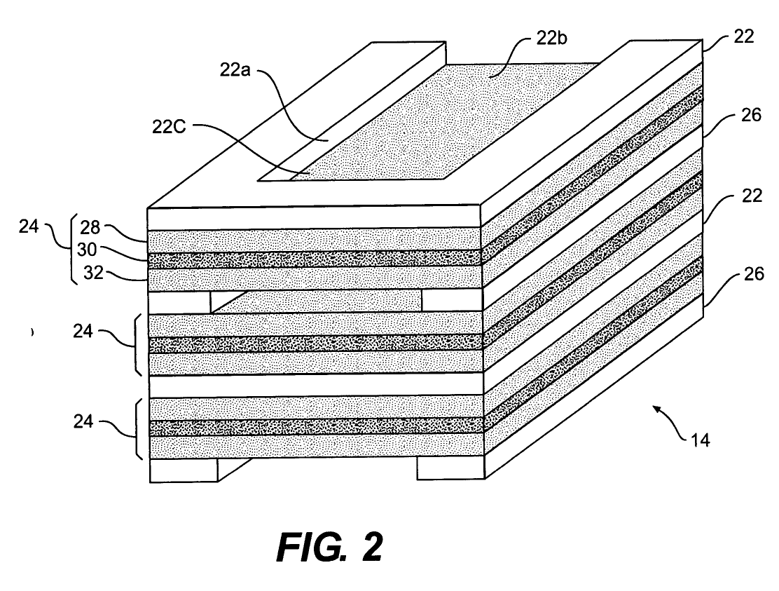

As illustrated in FIG. 2, inlet flow members 22 may be generally U-shaped and configured to direct a flow of exhaust through filter pack 24. In particular, each inlet flow member 22 may include a channel 22a having an open end 22b and a closed end 22c. Exhaust may be allowed to flow into channel 22a of inlet flow member 22 via open end 22b. Closed end 22c may block the flow of exhaust through channel 22a, thereby causing a generally orthogonal redirection of the flow through filter pack 24.

Each filter pack 24 may include three filtration layers configured to filter the flow of exhaust. Specifically, each filter pack 24 may include a first catalyzed filtration medium 28, a denser central particulate filtration medium 30, and a second catalyzed filtration medium 32. It is contemplated that additional or fewer catalyzed filtration media layers may be included and/or that additional particulate filtration media layers may be included.

First catalyzed filtration medium 28 may include a foam material having a catalyst configured to react with the exhaust flow entering filter packs 24. The foam material may be formed from sintered metallic particles such as, for example, alumina, titania, or any other high-temperature alloy. The foam material may also be formed from ceramic particles such as, for example, silicon carbide, cordierite, mullite, or any other ceramic particles known in the art. The foam material may be formed into two-sided sheets through a casting process, an injection molding process, or any other process that produces a porous material with a desired porosity. Typically, it is desired to have an average pore diameter generally in the range of 2-3 mm. In one example, each sheet of the foam material has a thickness of about 5 mm. The catalyst may be incorporated throughout the sheets of foam material and may be configured to reduce an amount of nitrogen oxide in the flow of exhaust, to decrease an oxidation temperature of the particulate matter trapped by particulate filtration medium 30, to reduce an amount of carbon monoxide in the flow of exhaust, and/or to reduce an amount of unburned hydrocarbons in the flow of exhaust. The catalyst may include, for example, an oxidation catalyst, an SCR catalyst, an HC-DeNOx catalyst, or any other appropriate catalyst.

Particulate filtration medium 30 may be in contact with first catalyzed filtration medium 28. For example, particulate filtration medium 30 may be generally planar and have a flow entrance side and a flow exit side with one of the flow entrance or flow exit sides being in contact with one side of first catalyzed filtration medium 28. Particulate filtration medium 30 may include a means for sealing a periphery of particulate filtration medium 30 to a periphery of first catalyzed filtration medium 28. The means for sealing may include, for example, a ceramic paste, a weld, a braze, a compression of a portion of particulate filtration medium 30 and/or first catalyzed filtration medium 28, a gasket, or any other means known in the art. In this manner, the exhaust flow from first catalyzed filtration medium 28 may be directed through particulate filtration medium 30.

Particulate filtration medium 30 be configured to remove particulate matter from the exhaust flow. Specifically, particulate filtration medium 30 may be a deep bed type filtration medium configured to accumulate particulate matter throughout a thickness of particulate filtration medium 30 in a substantially homogenous manner. Particulate filtration medium 30 may be a low density material formed into sheets through a sintering process from metallic or ceramic particles. A size generally in the range of 100-250 mesh may be desired in certain applications. It is contemplated that the sheets of low density material may include pleats to increase a filtration area of particulate filtration medium 30. Particulate filtration medium 30 may have a lower porosity level than the foam material of first catalyzed filtration medium 28, with a porosity generally in the range of 40-65% when measured with mercury porosimetry. The average pore diameter of particulate filtration medium 30 may be generally in the range of 20-60 μm, with a preferred average pore diameter of about 30-50 μm, and a most preferred average pore diameter of 45 μm. In one example, the layer of particulate filtration medium 30 has a thickness less than the thickness of first catalyzed filtration medium 28, with a thickness generally in the range of 0.5-3 mm.

Second catalyzed filtration medium 32 may include a foam material having a catalyst configured to react with the exhaust flow from particulate filtration medium 30. The foam material may be formed from sintered metallic particles such as, for example, alumina, titania, or any other high-temperature alloy. The foam material may also be formed from ceramic particles such as, for example, silicon carbide, cordierite, mullite, or any other ceramic particles known in the art. The foam material may be formed into two-sided sheets through a casting process, an injection molding process, or any other process that produces a porous material with an average pore size generally in the range of 2-3 mm. In one example, each sheet of the foam material has a thickness of about 5 mm. The catalyst may be incorporated throughout the sheets of foam material and may be configured to reduce an amount of nitrogen oxide in the flow of exhaust, to decrease an oxidation temperature of the particulate matter trapped by particulate filtration medium 30, to reduce an amount of carbon monoxide in the flow of exhaust, and/or to reduce an amount of unburned hydrocarbons in the flow of exhaust. The catalyst may include, for example, an oxidation catalyst, an SCR catalyst, an HC-DeNOx catalyst, or any other appropriate catalyst. It is contemplated that second catalyzed filtration medium 32 may have an identical catalyst or a different catalyst when compared with first catalyzed filtration medium 28.

Second catalyzed filtration medium 32 may be in contact with particulate filtration medium 30. For example, one side of second catalyzed filtration medium 32 may contact one of the flow entrance or flow exit sides of particulate filtration medium 30, opposite first catalyzed filtration medium 28, and may include a means for sealing a periphery of second catalyzed filtration medium 32 to a periphery of particulate filtration medium 30. The means for sealing may include, for example, a ceramic paste, a weld, a braze, a compression of a portion of second catalyzed filtration medium 32 and/or particulate filtration medium 30, a gasket, or any other means known in the art. In this manner, the exhaust flow from particulate filtration medium 30 may be directed through second catalyzed filtration medium 32.

Outlet flow members 26 may be generally U-shaped and configured to direct a flow of exhaust out of filter pack 24. In particular, each outlet flow member 26 may be substantially identical to inlet flow member 22 and include a channel having an open end and a closed end. Exhaust may be allowed to flow into the channel from second catalyzed filtration medium 32. The open end of the channel may allow the exhaust to flow through the channel to outlet 20, thereby facilitating a generally orthogonal redirection of the flow through filter pack 24.

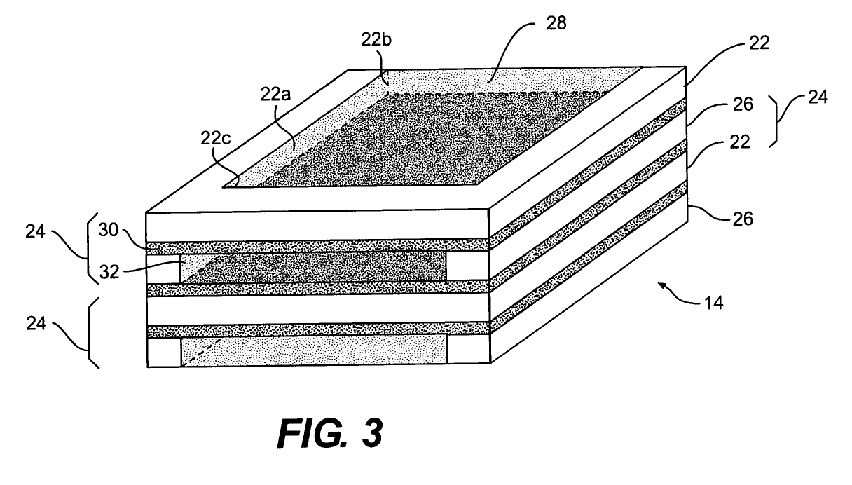

FIG. 3 illustrates another exemplary embodiment of filter assembly 14. Similar to FIG. 2, filter assembly 14 of FIG. 3 may include inlet flow members 22, filter pack 24 and outlet flow members 26. However, in contrast to the embodiment of FIG. 2, only particulate filtration medium 30 may be in contact with and sealed to both inlet flow member 22 and outlet flow member 26. In this embodiment, first catalyzed filtration medium 28 may be disposed within channel 22a of inlet flow member 22, while second catalyzed filtration medium 32 may be disposed within the channel of outlet flow member 26. In this manner, the overall size of filter assembly 14 and exhaust treatment device 10 may be reduced. It is contemplated that one of first catalyzed filtration medium 28 and one of second catalyzed filtration medium 32 may both be disposed within each of inlet and outlet flow members 22 and 26 when the catalyst of first catalyzed filtration medium 28 is different from the catalyst of second catalyzed filtration medium 32. In the embodiment of FIG. 3, the means for sealing first and second catalyzed filtration media 28, 32 to particulate filtration medium 30 may be omitted, if desired.

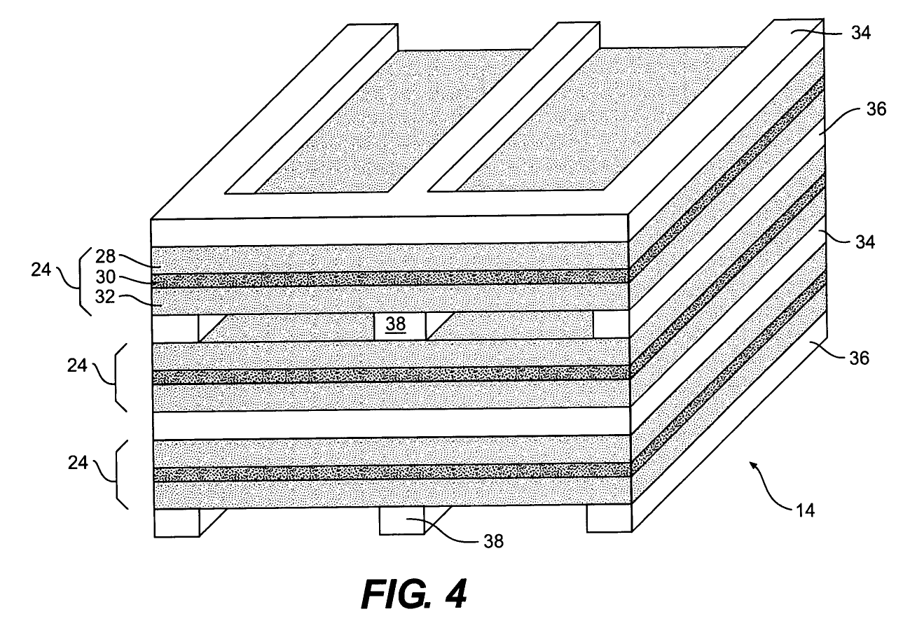

FIG. 4 illustrates another exemplary embodiment of filter assembly 14. Similar to FIG. 2, filter assembly 14 of FIG. 4 may include filter pack 24. However, in contrast to the embodiment of FIG. 2, filter assembly 14 of FIG. 4 may include inlet flow members 34 and outlet flow members 36. Each of inlet flow members 34 and outlet flow members 36 may include one or more central support members 38 forming multiple channels, each channel having an open end and a closed end. In this manner, inlet flow members 34 and outlet flow members 36 may provide both centralized support and peripheral support to filter packs 24. It is contemplated that any number of channels may be included within inlet flow members 34 and/or outlet flow members 36. It is also contemplated that one or more of first and/or second catalyzed filtration media 28, 32 may be disposed within each of the channels of inlet and outlet flow members 34, 36, rather than between inlet and outlet flow members 34, 36 and particulate filtration medium 30. It is further contemplated that a different one of first and second catalyzed filtration media 28, 32 may be disposed within each channel of inlet flow member 34 or outlet flow member 36.

### INDUSTRIAL APPLICABILITY

The disclosed filter assembly may be applicable to an exhaust treatment device used for any combustion-type system such as, for example, an engine, a furnace, or any other system known in the art where the removal of gaseous compounds and/or particulate matter from an exhaust flow is desirable. It is also contemplated that the disclosed filter assembly may also be used with a non-combustion type system such as, for example, a dust collection system.

Because filter packs 24 are designed for close stacking of one filter pack 24 on top of another filter pack 24, exhaust treatment device 10 may be compact with little or no wasted space between filter packs 24. Further, because first and second catalyzed filtration media 28, 32 are directly in contact with particulate filtration medium 30 and because first and/or second catalyzed filtration media 28, 32 may be disposed within channels of inlet and/or outlet flow members 22, 26, 34, 36, the overall size of exhaust treatment device 10 may be further reduced. In addition, because the number of filter packs 24 included within filter assemblies 14 may be variable within exhaust treatment device 10, the capacity of exhaust treatment device 10 may be configured to accommodate a variety of applications.

Because the catalyst may be distributed throughout the substantially thick porous material of first and second catalyzed filtration medium 28 and 32, through which all of the exhaust flows, the effectiveness of the catalyst may be greatly improved, as compared to a material having only a surface coating of catalyst. In addition, because particulate filtration medium 30 is a deep bed type filtration material, longer running times between regeneration events with a lower back pressure may be realized, as compared to surface type filtration medium.

It will be apparent to those skilled in the art that various modifications and variations can be made to the disclosed filter assembly without departing from the scope of the invention. Other embodiments of the invention will be apparent to those skilled in the art from consideration of the specification and practice of the invention disclosed herein. For example, additional components may be included within exhaust treatment device 10 such as a noise attenuation device, a regeneration device or system, a flow blocking mechanism, internal or external insulation, one or more diffusers or baffles, or other components known in the art. It is intended that the specification and examples be considered as exemplary only, with a true scope of the invention being indicated by the following claims and their equivalents.

What is claimed is:

1. A filter assembly, comprising:
an inlet flow member;
an outlet flow member;
a particulate filtration medium configured to remove particulate matter from an exhaust flow; and
at least one catalyzed filtration medium in contact with the particulate filtration medium and having a porosity greater than the particulate filtration medium.

2. The filter assembly of claim 1, wherein the catalyzed filtration medium includes a catalyst configured to reduce an amount of nitrogen oxide in the flow of exhaust.

3. The filter assembly of claim 1, wherein the catalyzed filtration medium includes a catalyst configured to lower an oxidation temperature of particulate matter trapped by the first filtration medium.

4. The filter assembly of claim 1, wherein the catalyzed filtration medium includes a catalyst configured to reduce an amount of carbon monoxide in the flow of exhaust.

5. The filter assembly of claim 1, wherein the catalyzed filtration medium includes a catalyst configured to reduce an amount of unburned hydrocarbons in the flow of exhaust.

6. The filter assembly of claim 1, wherein the at least one catalyzed filtration medium is disposed between the particulate filtration medium and one of the inlet and outlet flow members.

7. The filter assembly of claim 1, wherein the particulate filtration medium is disposed between the inlet and outlet flow members, at least one of the inlet and outlet flow members includes at least one channel, and the at least one catalyzed filtration medium is disposed within the at least one channel.

8. The filter assembly of claim 7, wherein the at least one channel includes a plurality of channels, the at least one catalyzed filtration medium includes a plurality of catalyzed filtration media, and one of the plurality of catalyzed filtration media is disposed within each of the plurality of channels.

9. The filter assembly of claim 1, wherein the at least one catalyzed filtration medium includes:
a first catalyzed filtration medium disposed between the inlet flow member and the first filtration medium; and
a second catalyzed filtration medium disposed between the outlet flow member and the first filtration medium.

10. The filter assembly of claim 1, wherein the particulate filtration medium is disposed between the inlet and outlet flow members, each of the inlet and outlet flow members includes at least one channel, and the at least one catalyzed filtration medium includes:
a first catalyzed filtration medium disposed within the at least one channel of the inlet flow member; and
a second catalyzed filtration medium disposed within the at least one channel of the outlet flow member.

11. The filter assembly of claim 1, wherein the particulate filtration medium is disposed between the inlet and outlet flow members, each of the inlet and outlet flow members includes a plurality of channels, and the at least one catalyzed filtration medium includes:
a first plurality of catalyzed filtration media, one of the first plurality of catalyzed filtration media being disposed within each of the plurality of channels of the inlet flow member; and
a second plurality of catalyzed filtration media, one of the second plurality of catalyzed filtration media being disposed within each of the plurality of channels of the outlet flow member.

12. The filter assembly of claim 1, further including a means for sealing the particulate filtration medium to the at least one catalyzed filtration medium.

13. The filter assembly of claim 1, further including a means for sealing the inlet and outlet flow members to at least one of the particulate filtration medium and the at least one catalyzed filtration medium.

14. The filter assembly of claim 1, wherein the flow of exhaust into and out of the filter assembly is substantially orthogonal to the flow of exhaust through the particulate filtration medium and the at least one catalyzed filtration medium.

15. The filter assembly of claim 1, wherein the particulate filtration medium has a thickness less than the thickness of the at least one catalyzed filtration medium.

16. The filter assembly of claim 1, wherein the particulate filtration medium is configured to collect particulate matter throughout a thickness of the particulate filtration medium in a substantially homogenous manner.

17. The filter assembly of claim 16, wherein the particulate filtration medium has an average pore size in the range of about 20-60 μm.

18. The filter assembly of claim 17, wherein the particulate filtration medium has an average pore size of about 45 μm.

19. The filter assembly of claim 16, wherein the particulate filtration medium has a porosity in the range of about 40-60% when measured with mercury porosimetry.

20. The filter assembly of claim 16, wherein the particulate filtration medium includes a low density ceramic.

21. The filter assembly of claim 16, wherein the particulate filtration medium includes a low density metal.

22. The filter assembly of claim 16, wherein the particulate filtration medium is formed through a sintering process from particles having a size in the range of about 100-250 mesh.

23. The filter assembly of claim 1, wherein the at least one catalyzed filtration medium includes one of a ceramic foam and a metallic foam.

24. The filter assembly of claim 23, wherein the at least one catalyzed filtration medium has a pore size in the range of about 2-3 mm.

25. A method of treating an exhaust flow, comprising:
directing the exhaust flow through an inlet flow member;
directing the exhaust flow through a particulate filtration medium to remove particulates from the exhaust flow;
directing the exhaust flow through at least one catalyzed filtration medium that is in contact with the particulate filtration medium and has a porosity greater than the particulate filtration medium; and
directing the exhaust flow through an outlet flow member.

26. The method of claim 25, wherein directing the exhaust flow through at least one catalyzed filtration medium reduces an amount of nitrogen oxide in the exhaust flow.

27. The method of claim 25, wherein directing the exhaust flow through at least one catalyzed filtration medium reduces an oxidation temperature of the particulates trapped within the particulate filtration medium.

28. The method of claim 25, wherein directing the exhaust flow through at least one catalyzed filtration medium reduces an amount of carbon monoxide in the flow of exhaust.

29. The method of claim 25, wherein directing the exhaust flow through at least one catalyzed filtration medium reduces an amount of unburned hydrocarbons in the flow of exhaust.

30. The method of claim 25, wherein the step of directing the exhaust flow through at least one catalyzed filtration medium is performed before and after the step of directing the exhaust flow through the particulate filtration medium.

31. The method of claim 25, wherein the step of directing the exhaust flow through the inlet flow member includes:
directing the exhaust flow into the inlet flow member in a first flow direction; and
directing the exhaust flow out of the inlet flow member in a second flow direction orthogonal to the first flow direction.

32. An exhaust treatment device, comprising:
a housing including:
an inlet;
an outlet; and
a main chamber located between the inlet and the outlet; and
at least one filter assembly disposed within the main chamber of the housing, the filter assembly including:
an inlet flow member in fluid communication with the inlet;
an outlet flow member in fluid communication with the outlet;
a particulate filtration medium configured to remove particulate matter from an exhaust flow; and
at least one catalyzed filtration medium in contact with the particulate filtration medium and having a porosity greater than the particulate filtration medium.

33. The exhaust treatment device of claim 32, wherein the catalyzed filtration medium includes at least one of a catalyst configured to reduce an amount of nitrogen oxide in the flow of exhaust, a catalyst configured to lower an oxidation temperature of particulate matter trapped by the first filtration medium, a catalyst configured to reduce an amount of carbon monoxide in the flow of exhaust, and a catalyst configured to reduce an amount of unburned hydrocarbons in the flow of exhaust.

34. The exhaust treatment device of claim 32, wherein the at least one catalyzed filtration medium is disposed between the particulate filtration medium and one of the inlet and outlet flow members.

35. The exhaust treatment device of claim 32, wherein the particulate filtration medium is disposed between the inlet and outlet flow members, at least one of the inlet and outlet flow members includes at least one channel, and the at least one catalyzed filtration medium is disposed within the at least one channel.

36. The exhaust treatment device of claim 35, wherein the at least one channel includes a plurality of channels, the at least one catalyzed filtration medium includes a plurality of catalyzed filtration media, and one of the plurality of catalyzed filtration media is disposed within each of the plurality of channels.

37. The exhaust treatment device of claim 32, wherein the at least one catalyzed filtration medium includes:
a first catalyzed filtration medium disposed between the inlet flow member and the first filtration medium; and
a second catalyzed filtration medium disposed between the outlet flow member and the first filtration medium.

38. The exhaust treatment device of claim 32, wherein the particulate filtration medium is disposed between the inlet and outlet flow members, each of the inlet and outlet flow members includes at least one channel, and the at least one catalyzed filtration medium includes:
a first catalyzed filtration medium disposed within the at least one channel of the inlet flow member; and
a second catalyzed filtration medium disposed within the at least one channel of the outlet flow member.

39. The exhaust treatment device of claim 32, wherein the particulate filtration medium is disposed between the inlet and outlet flow members, each of the inlet and outlet flow members includes a plurality of channels, and the at least one catalyzed filtration medium includes:
a first plurality of catalyzed filtration media, one of the first plurality of catalyzed filtration media being disposed within each of the plurality of channels of the inlet flow member; and
a second plurality of catalyzed filtration media, one of the second plurality of catalyzed filtration media being disposed within each of the plurality of channels of the outlet flow member.

40. The filter assembly of claim 32, further including:
a means for sealing the particulate filtration medium to the at least one catalyzed filtration medium; and
a means for sealing the inlet and outlet flow members to at least one of the particulate filtration medium and the at least one catalyzed filtration medium.

41. The exhaust treatment device of claim 32, wherein the particulate filtration medium includes at least one of a low density ceramic and a low density metal formed through a sintering process from particles having a size between about 100-250 mesh, has a thickness less than the thickness of the at least one catalyzed filtration medium, and is configured to collect particulate matter throughout a thickness of the particulate filtration medium in a substantially homogenous manner.

42. The exhaust treatment device of claim 41, wherein the particulate filtration medium has:
an average pore size in the range of about 20-60 μm; and
a porosity in the range of about 40-60% when measured with mercury porosimetry.

43. The exhaust treatment device of claim 42, wherein the particulate filtration medium has an average pore size of about 45 μm.

44. The exhaust treatment device of claim 32, wherein the at least one catalyzed filtration medium includes one of a ceramic foam and a metallic foam, and has a pore size in the range of about 2-3 mm.
